(19) United States
(12) Patent Application Publication
(10) Pub. No.: US 2005/0162344 A1
(43) Pub. Date: Jul. 28, 2005

(54) Method and apparatus for controlling initialization in plasma display panel

(76) Inventors: Seong Ho Kang, Buk-gu (KR); Sang Jin Yoon, Chilgok-gun (KR)

Correspondence Address: MCKENNA LONG & ALDRIDGE LLP, 1900 K STREET, NW, WASHINGTON, DC, 20006, US

(21) Appl. No.: 10/986,157

(22) Filed: Nov. 12, 2004

(30) Foreign Application Priority Data
Nov. 12, 2003 (KR) 10-2003-0079783

(51) Int. Cl. G09G 3/28

(52) U.S. Cl. 345/60

(57) ABSTRACT

The present invention relates to a plasma display panel, and more particularly, to a method and apparatus for controlling initialization in plasma display panel. The method and apparatus for controlling initialization in plasma display panel according to the present invention time divides a frame period into a plurality of sub fields which are capable of abbreviating an initialization signal for initialization discharge or are capable of controlling the voltage of the initialization signal according to an average luminosity of input image, increasing the number of sub fields abbreviating the initialization signal or increasing the number of sub fields having low initialization signal voltage when the average luminosity of input image is lower than a average luminosity of previous input image.

This Nonprovisional application claims priority under 35 U.S.C. § 119(a) on Patent Application No. 10-2003-0079783 filed in Korea on Nov. 12, 2003, the entire contents of which are hereby incorporated by reference.

### BACKGROUND OF THE INVENTION

1. Field of the Invention

The present invention relates to a plasma display panel, and more particularly, to a method and apparatus for controlling initialization in plasma display panel.

2. Description of the Background Art

A Plasma display panel (hereinafter, referred to as “PDP”) is adapted to display an image by light-emitting phosphors with ultraviolet rays generated during the discharge of an inert mixed gas such as He+Xe or He+Xe.

This PDP can be easily made thin and large, and it can provide greatly enhanced picture quality compared to CRT (Cathode Ray Tube) which has been main display means.

FIG. 1 is a plan view schematically represents a conventional plasma display panel. FIG. 2 is a perspective view illustrating the conventional structure of a cell shown in FIG. 1 in detail. Referring to FIG. 1 and FIG. 2, three-electrode AC surface discharge type PDP includes a plurality of scan electrodes Y such as Y1, Y2, Yn and a plurality of sustain electrodes Z which are formed on the bottom surface of an upper substrate 10, and an address electrode X such as X1, X2, Xm-1, Xm formed on a lower substrate 18.

The discharge cell 1 of the PDP is formed at every crossing of the scan electrodes Y, the sustain electrodes Z and the address electrodes X and is arranged in a matrix form. Each of the scan electrode Y and the sustain electrode Z includes a transparent electrode 12, and a metal bus electrode 11 that has a line width smaller than the transparent electrode 12 and is disposed at one side of the transparent electrode.

The transparent electrode 12, which is generally made of ITO (indium tin oxide), is formed on the bottom surface of the upper substrate 10. The metal bus electrode 11 is generally formed of a metal on the transparent electrode 12 and serves to reduce a voltage drop caused by the transparent electrode 12 having high resistance. On the bottom surface of the upper substrate 10 in which the scan electrodes Y and the sustain electrodes are disposed is laminated an upper dielectric layer 13 and a protective layer 14. The upper dielectric layer 13 is accumulated with a wall charge generated during plasma discharging. The protective layer 14 is adapted to prevent damages of the electrodes Y and Z and the upper dielectric layer 13 due to sputtering caused during plasma discharging, and improve efficiency of secondary electron emission. As the protective layer 14, magnesium oxide (MgO) is generally used.

The address electrodes X are formed on the lower substrate 18 in the direction that they intersect the scan electrodes Y and the sustain electrodes Z. A lower dielectric layer 17 and a diaphragm 15 are formed on the lower substrate 18. A phosphor layer 16 is formed on the surface of the lower dielectric layer 17 and the diaphragm 15. The diaphragm 15 is formed abreast with the address electrodes X, physically sectioning the discharge cell, isolating electrical and optical interference between the adjacent discharge cells. The phosphor layer 16 is excited with ultraviolet rays generated during the plasma discharging to generate one of visible lights that are red, green and blue light.

An inert mixed gas such as He+Xe, Ne+Xe or He+Xe+Ne for discharge is injected into the discharge space of the discharge cells provided between the upper and lower substrates 10, 18 and the diaphragm 15.

Such PDP is time-divided driven in such a way to implement the gray level that one frame is divided into several sub fields of different emission numbers. Each of the sub fields is divided into a reset period for uniform discharging, an address period for selecting a discharge cell, and a sustain period for implementing the gray level according to the number of discharge.

FIG. 3 shows a conventional sub field pattern which is formed by time-dividing one frame period into a plurality of sub fields. If an image is to be represented using 256 gray levels, a frame period (16.67 ms) corresponding to 1/60 second is divided into 8 sub fields SF1 to SF8, as shown in FIG. 3. Then, each of the sub fields SF1 to SF8 is divided into a reset period, an address period and a sustain period.

The reset period and the address period of each of the sub fields SF1 to SF8 are the same in every sub fields, whereas the sustain period and its discharge number increase in the ratio of 2ⁿ (n=0,1,2,3,4,5,6,7) in each sub field. Thus, it is able to implement the gray level of image on account of the variation of the sustain period in each of the sub fields SF1 to SF8.

FIG. 4 is a waveform diagram representing conventional driving signal for driving plasma display panel such as shown in FIG. 1, showing driving signals applied to electrodes of PDP in each of the sub fields SF1 to SF8.

Referring to FIG. 4, in the initial stage of reset period, Ramp-up waveform Ramp-up is applied to every scan electrode Y simultaneously. At the same time, O[V] is applied to the sustain electrodes Z and the address electrodes X. Between the scan electrodes Y and the address electrodes X and between the scan electrodes Y and the sustain electrodes Z, a write discharge as weak discharge is performed within cells of the entire screen by means of Ramp-up signal. On account of the write discharge, wall charges of the positive polarity (+) are accumulated in the address electrodes X and the sustain electrodes Z, wall charges of the negative polarity (−) are accumulated in the scan electrodes Y.

After the supplying Ramp-up signal, Ramp-down waveform Ramp-dn decreasing from sustain voltage Vs which is lower than the peak voltage of Ramp-up waveform Ramp-up to scan bias voltage −Vy of the negative polarity (−) is applied to the scan electrodes Y simultaneously. At the same time, bias voltage Vz-bias of sustain voltage Vs is applied to the sustain electrodes Z, O[V] is applied to the address electrodes X. When Ramp-down waveform Ramp-dn is applied, an erase discharge as weak discharge is performed between scan electrodes Y and the sustain electrodes Z and between scan electrodes Y and the address electrodes X. The erase discharge erases excessive wall charges which are unnecessary for address discharge among wall charges formed in write discharge.

During address period, scan pulse scp of the negative polarity (−) is applied to the scan electrodes Y successively. At the same time, data pulse of the positive polarity (+) dp is applied to the address electrodes X synchronized with scan pulse scp. Address discharge is performed in the cell which is supplied with data pulse dp on account of adding wall voltage generated in reset period to voltage difference between scan pulse scp and data pulse dp. Wall charges are formed in the cells which are selected by address discharge in such a dgree that is capable of discharge when sustain voltage Vs is applied. During the address period, DC voltage of the positive polarity (+) Zdc is applied to the sustain electrodes Z.

During the sustain period, sustain pulse sus is applied to the scan electrodes Y and the sustain electrodes Z alternately. Then, discharge cells which are selected by address discharge generate sustain discharge, in other words, display discharge between the scan electrodes Y and the sustain electrodes Z with each of the sustain pulse sus1 to sus6 while wall voltage of the discharge cell is added to sustain pulse sus. The number of sustain pulse is differently determined in each subfield according to luminance weight given to each of the sub fields SF1 to SF8.

After the completion of sustain discharge, erase ramp signal (not shown) is applied to the scan electrodes Y or the sustain electrodes Z. Eimination ramp signal erases wall charges generated by sustain discharge through performing erase discharge as weak discharge in the cell.

In the mean time, PDP has a drawback that contrast ratio is low on account of the light emitted in the period of non-display. For example, a few times discharges in the whole discharge cells during the reset period assigned to each sub field, in particular, write discharge performed by Ramp-up waveform Ramp-up or set up discharge are accompanied with a light emitting which causes the increase of black luminance.

Furthermore, PDP has a problem that address period or sustain period is constricted as much as reset period because that reset period is assigned to each sub field. For example, it is difficult to add sub field for decreasing of bad image factor such as contour noise or to add sustain pulse for increasing of luminance on account of reset period assigned to each sub field.

### SUMMARY OF THE INVENTION

Accordingly, an object of the present invention is to solve at least the problems and disadvantages of the background art.

It is an object of the present invention to provide a method and apparatus for PDP initialization control capable of improving contrast and of reducing reset time.

According to a first embodiment of the present invention, there is provided a method for initialization control of a PDP including the steps of time-dividing a frame period into a plurality of sub fields which are capable of abbreviating an initialization signal for initialization discharge or are capable of controlling the voltage of the initialization signal according to an average luminosity of input image; and increasing the number of sub fields abbreviating the initialization signal or increasing the number of sub fields having low initialization signal voltage when the average luminosity of input image is lower than a average luminosity of previous input image.

According to second embodiment of the present invention, there is also provided a method for initialization control of a PDP including the steps of time-dividing a frame period into a plurality of sub fields which are capable of abbreviating an initialization signal for initialization discharge or are capable of controlling the voltage of the initialization signal according to an average luminosity of input image; performing cell initialization by means of the initialization signal in each sub field when the average luminosity of input image is a predetermined value; increasing the number of sub fields abbreviating the initialization signal or increasing the number of sub fields having low initialization signal voltage when the average luminosity of input image is lower than the predetermined value; and increasing the number of sub fields abbreviating the initialization signal or increasing the number of sub fields having low initialization signal voltage when the average luminosity of input image is higher than the predetermined value.

An apparatus for driving a PDP according to the first embodiment of the present invention includes a plasma display panel which is time-divided driven with a plurality of sub fields which are capable of abbreviating an initialization signal for initialization discharge or are capable of controlling the voltage of the initialization signal according to an average luminosity of input image; an APL calculating part caculating the average luminosity of input image; and an initialization control part increasing the number of sub fields abbreviating the initialization signal or increasing the number of sub fields having low initialization signal voltage when the average luminosity of input image calculated by the APL calculating part is lower than a average luminosity of previous input image.

An apparatus for driving a PDP according to the second embodiment of the present invention includes a plasma display panel which is time-divided driven with a plurality of sub fields which are capable of abbreviating an initialization signal for initialization discharge or are capable of controlling the voltage of the initialization signal according to an average luminosity of input image; an APL calculating part caculating the average luminosity of input image; a first initialization control part providing the initialization signal with the plasma display panel in each sub field when the average luminosity of input image calculated by the APL calculating part is a predetermined value; a second initialization control part increasing the number of sub fields abbreviating the initialization signal or increasing the number of sub fields having low initialization signal voltage when the average luminosity of input image is lower than the predetermined value; and a third initialization control part increasing the number of sub fields abbreviating the initialization signal or increasing the number of sub fields having low initialization signal voltage when the average luminosity of input image is higher than the predetermined value.

The method and apparatus for controlling initialization in plasma display panel according to the present invention abbreviates Ramp up signals or lessens the set-up voltage when APL is lower than the predetermined value and/or APL is higher than the predetermined value. As a result, the present invention is able to improve contrast ratio and is able to shorten reset period because that light emiting that is accompanied by discharge is diminished on account of decreasing the number of the initialization discharge or performing weak initialization discharge.

### BRIEF DESCRIPTION OF THE DRAWINGS

The invention will be described in detail with reference to the following drawings in which like numerals refer to like elements.

FIG. 1 is a plan view schematically represents a conventional plasma display panel.

FIG. 2 is a perspective view illustrating the conventional structure of a cell shown in FIG. 1 in detail.

FIG. 3 shows a conventional sub field pattern which is formed by time-dividing one frame period into a plurality of sub fields.

FIG. 4 is a waveform diagram representing conventional driving signal for driving plasma display panel such as shown in FIG. 1

FIG. 5 is a flow chart representing the procedure of control in the initialization control method of plasma display panel according to a first embodiment of the present invention.

FIG. 6 is a flow chart representing the procedure of control in the initialization control method of plasma display panel according to a second embodiment of the present invention.

FIG. 7 is a waveform diagram representing driving signal of subfield omitting Ramp-up waveformin the initialization control method of plasma display panel according to the first embodiment and the second embodiment of the present invention.

FIG. 8 is a flow chart representing the procedure of control in the initialization control method of plasma display panel according to a third embodiment of the present invention.

FIG. 9 is a flow chart representing the procedure of control in the initialization control method of plasma display panel according to a fourth embodiment of the present invention.

FIG. 10 is a waveform diagram representing the set-up voltage of Ramp-up waveform which varies with the average luminance in the initialization control method of plasma display panel according to the third embodiment and the fourth embodiment of the present invention.

FIG. 11 is a flow chart representing the procedure of control in the initialization control method of plasma display panel according to a fifth embodiment of the present invention.

FIG. 12 is a flow chart representing the procedure of control in the initialization control method of plasma display panel according to a sixth embodiment of the present invention.

FIG. 13 is a block diagram representing the initialization control means of plasma display panel according to the embodiments of the present invention

FIG. 14 is a block diagram representing the waveform generating part in FIG. 13 in detail.

FIG. 15 is a graphical representation of APL calculated in APL calculating part shown in FIG. 13 and the number of sustain pulse according to APL.

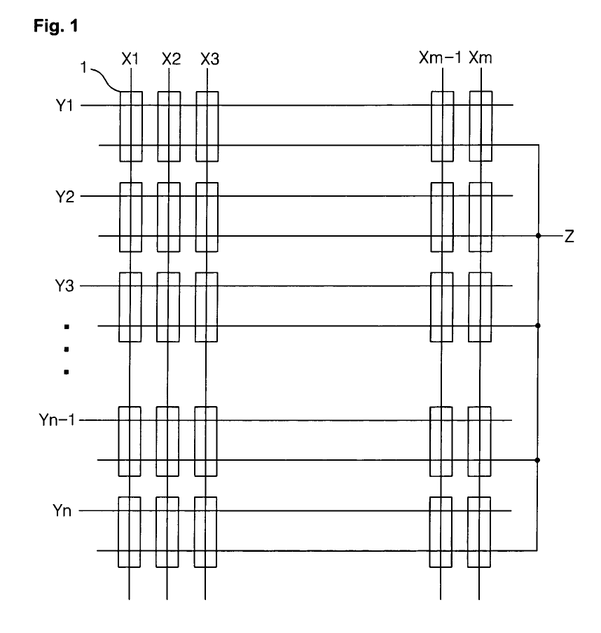

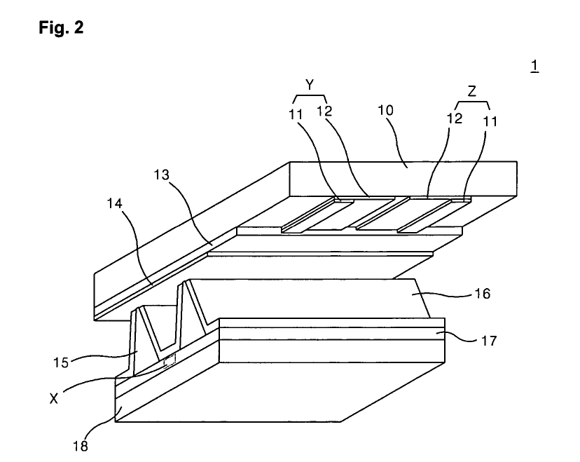

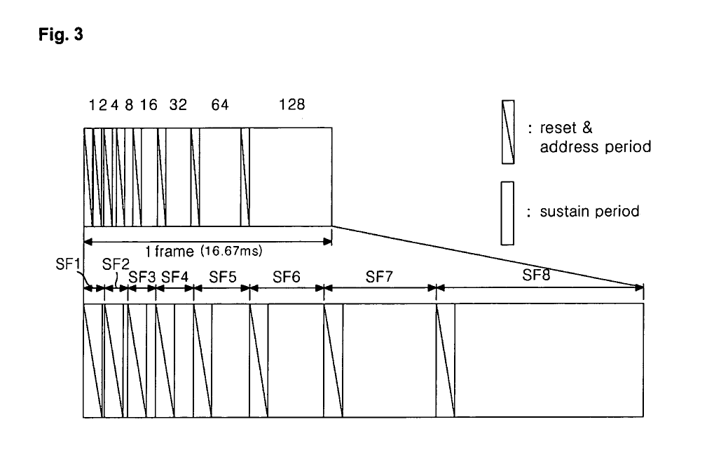

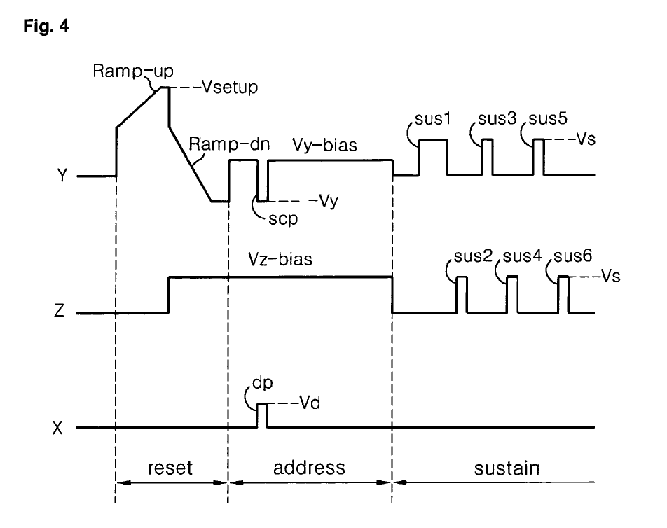

### DETAILED DESCRIPTION OF PREFERRED EMBODIMENTS

Preferred embodiments of the present invention will be described in a more detailed manner with reference to the drawings.

A method for initialization control of a PDP according to a first embodiment of the present invention includes the steps of time-dividing a frame period into a plurality of sub fields which are capable of abbreviating an initialization signal for initialization discharge or are capable of controlling the voltage of the initialization signal according to an average luminosity of input image; and increasing the number of sub fields abbreviating the initialization signal or increasing the number of sub fields having low initialization signal voltage when the average luminosity of input image is lower than a average luminosity of previous input image.

A method for initialization control of a PDP according to a second embodiment of the present invention includes the steps of time-dividing a frame period into a plurality of sub fields which are capable of abbreviating an initialization signal for initialization discharge or are capable of controlling the voltage of the initialization signal according to an average luminosity of input image; performing cell initialization by means of the initialization signal in each sub field when the average luminosity of input image is a predetermined value; increasing the number of sub fields abbreviating the initialization signal or increasing the number of sub fields having low initialization signal voltage when the average luminosity of input image is lower than the predetermined value; and increasing the number of sub fields abbreviating the initialization signal or increasing the number of sub fields having low initialization signal voltage when the average luminosity of input image is higher than the predetermined value.

The initialization signal is a ramp signal for performing write discharge as weak discharge with gradual rising of voltage.

An apparatus for initialization control of PDP according to the first embodiment of the present invention includes a plasma display panel which is time-divided driven with a plurality of sub fields which are capable of abbreviating an initialization signal for initialization discharge or are capable of controlling the voltage of the initialization signal according to an average luminosity of input image; an APL calculating part caculating the average luminosity of input image; and an initialization control part increasing the number of sub fields abbreviating the initialization signal or increasing the number of sub fields having low initialization signal voltage when the average luminosity of input image calculated by the APL calculating part is lower than a average luminosity of previous input image.

The initialization control part comprises an initialization signal generating part generating the initialization signal; and a control part for controlling the initialization signal generating part in response to the average luminosity signal calculated by the APL calculating part.

An apparatus for initialization control of PDP according to the second embodiment of the present invention includes a plasma display panel which is time-divided driven with a plurality of sub fields which are capable of abbreviating an initialization signal for initialization discharge or are capable of controlling the voltage of the initialization signal according to an average luminosity of input image; an APL calculating part caculating the average luminosity of input image; a first initialization control part providing the initialization signal with the plasma display panel in each sub field when the average luminosity of input image calculated by the APL calculating part is a predetermined value; a second initialization control part increasing the number of sub fields abbreviating the initialization signal or increasing the number of sub fields having low initialization signal voltage when the average luminosity of input image is lower than the predetermined value; and a third initialization control part increasing the number of sub fields abbreviating the initialization signal or increasing the number of sub fields having low initialization signal voltage when the average luminosity of input image is higher than the predetermined value.

The first, second and third initialization control part comprise an initialization signal generating part generating the initialization signal; and a control part for controlling the initialization signal generating part in response to the average luminosity signal calculated by the APL calculating part.

Hereafter, the first and second embodiments of the present invention will now be explained in more detail with reference to the attached drawings.

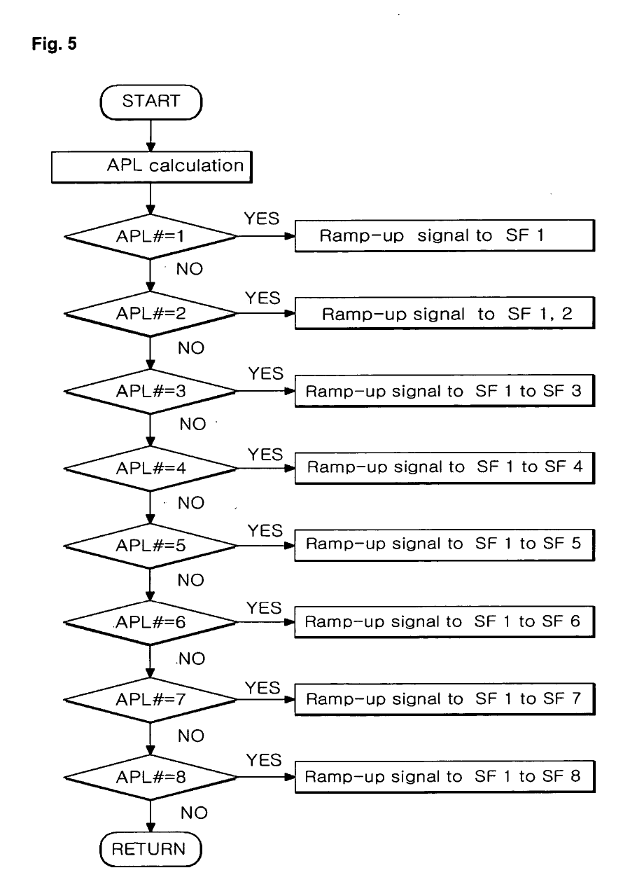

FIG. 5 is a flow chart representing the procedure of control in the initialization control method of plasma display panel according to a first embodiment of the present invention.

A method for initialization control of a PDP according to the first embodiment of the present invention calculates Average Picture Level APL of a screen, then the lower APL is, the more Ramp-up signals are abbreviated in sub fields having high weight.

It is supposed that the number of sub field is eight and the sub field pattern is able to represent maximum 1024 gray level in table 1 and FIG. 5. Table 1 and FIG. 5 show that whether Ramp-up signals are abbreviated or not in the method for initialization control of a PDP according to the first embodiment of the present invention. Hereinafter, O represents existing and X represents non-existing

TABLE 1

| | SF1 | SF2 | SF3 | SF4 | SF5 | SF6 | SF7 | SF8 |
|---|---|---|---|---|---|---|---|---|
| | (1 k) | (2 k) | (4 k) | (8 k) | (16 k) | (32 k) | (64 k) | (128 k) |
| APL1 | ◯ | X | X | X | X | X | X | X |
| APL2 | ◯ | ◯ | X | X | X | X | X | X |
| APL3 | ◯ | ◯ | ◯ | X | X | X | X | X |
| APL4 | ◯ | ◯ | ◯ | ◯ | X | X | X | X |
| APL5 | ◯ | ◯ | ◯ | ◯ | ◯ | X | X | X |
| APL6 | ◯ | ◯ | ◯ | ◯ | ◯ | ◯ | X | X |
| APL7 | ◯ | ◯ | ◯ | ◯ | ◯ | ◯ | X | X |
| APL8 | ◯ | ◯ | ◯ | ◯ | ◯ | ◯ | ◯ | X |

In table 1, the number of ( ) is a luminance weight assigned to each sub field, k is a value which multiplies the luminance weight maximum four times according to APL. For example, when APL is low, the weight of the eighth sub field SF8 128 is adjusted to ‘256’, ‘384’, ‘512’.

APL is subdivided into 1024 steps such as 0 to 1024 corresponding to maximum 1024 gray levels. APL of 1024 steps is divided into eight APL group as shown in table 1. A first APL group APL1 which is the lowest range APL comprises 0 to 100 step APL. A second APL group APL2 comprises 101 to 200 step APL. A third APL group APL3 comprises 201 to 300 step APL. A fourth APL group APL4 comprises 301 to 400 step APL. A fifth APL group APL5 comprises 401 to 500 step APL. A sixth APL group APL6 comprises 501 to 600 step APL. A seventh APL group APL7 comprises 601 to 700 step APL. A eighth APL group APL8 comprises 701 to 800 step APL.

As shown in table 1 and FIG. 5, if APL is calculated as the first APL group APL1, Ramp-up signals are only assigned to a first sub field SF1 having the lowest luminance weight and not assigned to any other sub fields SF2 to SF8. If APL is calculated as the second APL group APL2 that is 101 to 200 APL, Ramp-up signals are only assigned to the first and second sub field SF1, SF2. If APL is calculated as the seventh APL group APL7 that is 601 to 700 APL while a screen turns bright, Ramp-up signals are assigned to the first sub field to seventh sub field SF1 to SF7 except the eighth sub field SF8. If APL is calculated as the eighth APL group APL8 that is 701 to 1023 APL while the screen turns bright with a luminosity accessing to peak white, Ramp-up signals are assigned to all sub field SF1 to SF8.

If APL is low, in other words, if the screen is comparatively dark, data are positioned in sub fields having low luminance weight such as the first sub field to the third sub field SF1 to SF3 corresponding to Least Significant Bits LSB, while data are rarely positioned in sub fields corresponding to Most Significant Bits MSB.

Accordinly, the method for initialization control of a PDP according to the first embodiment of the present invention improves contrast ratio by lowering black luminance in a dark screen by means of diminishing or abbreviating of reset period in sub fields with high luminance weight having no data, in other words, having few cells that is turned on while the initialization of sub fields in which data are exist in the dark screen is stabilized. Also, the method for initialization control of a PDP according to the first embodiment of the present invention is able to meet enough driving margin in each sub field by means of stabilizing the initialization of almost every sub field that data can exist through increasing the number of sub fields including reset period in a bright screen.

In the mean time, Ramp-down signal Ramp-dn may be assigned to each sub field may be abbreviated with Ramp-up signal according to APL.

The method for initialization control of a PDP according to the second embodiment of the present invention calculates APL of a screen. The lower APL is, the more Ramp-up signals of sub fields having high weight are abbreviated. The higher APL is, the more Ramp-up signals of sub fields having low weight are abbreviated.

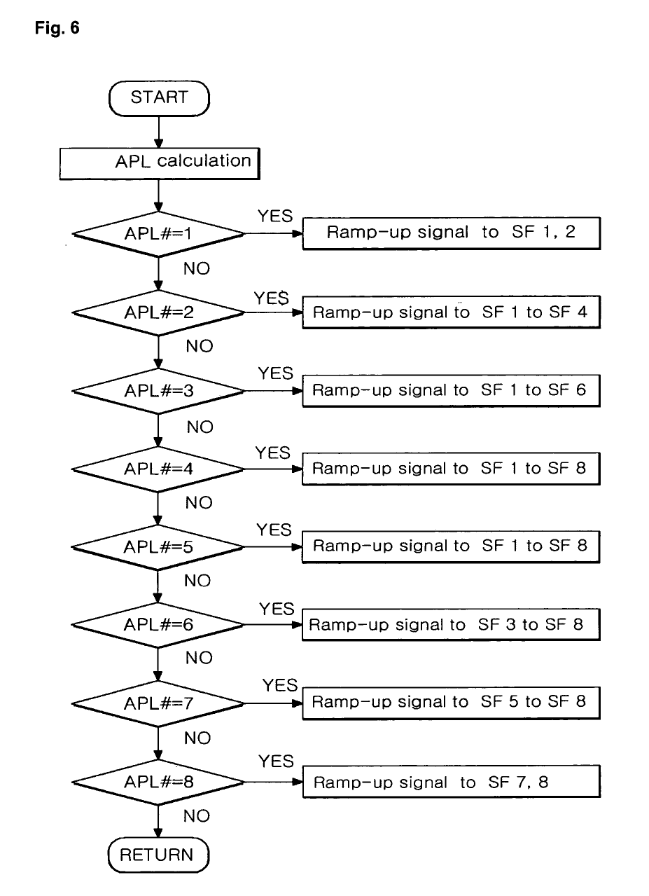

FIG. 6 is a flow chart representing the procedure of control in the initialization control method of plasma display panel according to a second embodiment of the present invention. It is supposed that the number of sub field is eight and the sub field pattern is able to represent maximum 1024 gray level in table 2 and FIG. 6. Table 2 and FIG. 6 show that whether Ramp-up signals are abbreviated or not in the method for initialization control of a PDP according to the second embodiment of the present invention.

TABLE 2

| | SF1 | SF2 | SF3 | SF4 | SF5 | SF6 | SF7 | SF8 |
|---|---|---|---|---|---|---|---|---|
| | (1k) | (2k) | (4k) | (8k) | (16k) | (32k) | (64k) | (128k) |
| APL1 | ◯ | ◯ | X | X | X | X | X | X |
| APL2 | ◯ | ◯ | ◯ | ◯ | X | X | X | X |
| APL3 | ◯ | ◯ | ◯ | ◯ | ◯ | ◯ | X | X |
| APL4 | ◯ | ◯ | ◯ | ◯ | ◯ | ◯ | ◯ | ◯ |
| APL5 | ◯ | ◯ | ◯ | ◯ | ◯ | ◯ | ◯ | ◯ |
| APL6 | X | X | ◯ | ◯ | ◯ | ◯ | ◯ | ◯ |
| APL7 | X | X | X | X | ◯ | ◯ | ◯ | ◯ |
| APL8 | X | X | X | X | X | X | ◯ | ◯ |

As shown in table 2 and FIG. 6, if APL is calculated as the first APL group APL1, Ramp-up signals are only assigned to a first sub field and the second sub field SF1, SF2 having the lowest luminance weight and not assigned to any other sub fields SF3 to SF8. If APL is calculated as a second APL group APL2 that is 0 to 100 APL, Ramp-up signals are assigned to the first sub field to the fourth sub field SF1 to SF4. If APL is calculated as the third APL group APL3 Ramp-up signals are assigned to the first sub field to the sixth sub field SF1 to SF6.

If APL is calculated in a fourth and fifth APL group APL4, APL5, while the screen turns bright in the middle luminosity, Ramp-up signals are assigned to all sub fields SF1 to SF8.

If APL is calculated as the sixth APL group APL6, while the screen turns bright, Ramp-up signals are assigned to the third sub field to eighth sub field SF3 to SF8. If APL is calculated as the seventh APL group APL7, Ramp-up signals are assigned to the fifth sub field to eighth sub field SF5 to SF8. If APL is calculated as the eighth APL group APL8, while the screen turns bright with a luminosity accessing to peak white, Ramp-up signals are assigned to the seventh sub field and eighth sub field SF7, SF8.

If APL is low, in other words, if the screen is comparatively dark, data are positioned in sub fields having low luminance weight such as the first sub field to the third sub field SF1 to SF3 corresponding to Least Significant Bits LSB, while data are rarely positioned in sub fields corresponding to Most Significant Bits MSB. The discharge characteristics of discharge cells are stabilized when the priming effect that charge particles are increased and stabilized with the increase of the number of discharge is strong.

Accordinly, the method for initialization control of a PDP according to the second embodiment of the present invention improves contrast ratio by lowering black luminance in a dark screen by means of diminishing or abbreviating of reset period in sub fields with high luminance weight having no data, in other words, having few cells that is turned on while the initialization of sub fields in which data are exist in the dark screen is stabilized.

Also, the method for initialization control of a PDP according to the first embodiment of the present invention increases the number of sub fields abbreviating Ramp-up signalson account of the increase of the number of discharges, while luminosity is higher in the bright screen having comparatively higher driving margin in each sub field. Reset period is abbreviated in the sub fields having low luminance weight corresponding to MSB as the sub fields abbreviating Ramp-up signalsin the bright screen have high probability that data exist in MSB.

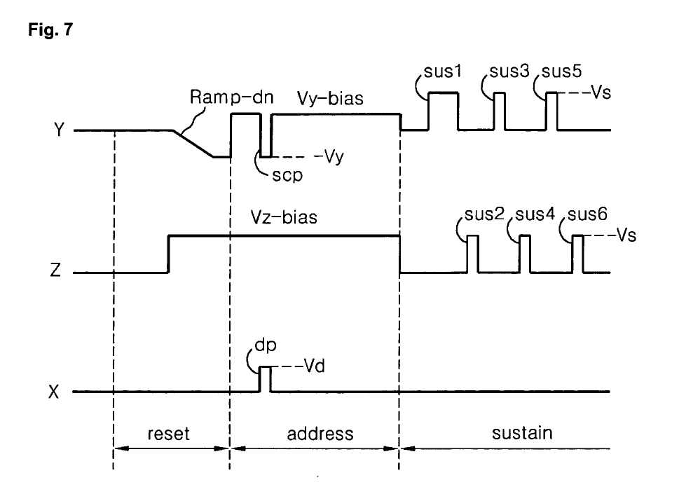

FIG. 7 is a waveform diagram representing driving signal of subfield omitting Ramp-up waveformin the initialization control method of plasma display panel according to the first embodiment and the second embodiment of the present invention. As shown in FIG. 7, the first embodiment and the second embodiment of the present invention reduces reset period as Ramp-up signals are abbreviated in sub fields that data rarely exist in probability. Black luminance is decreased as write discharge is not performed in reset period.

The method for initialization control of a PDP according to the third embodiment of the present invention decreases the set up voltage Vsetup of Ramp-up signals in the sub fields SF2 to SF8 except a first sub field SF1.

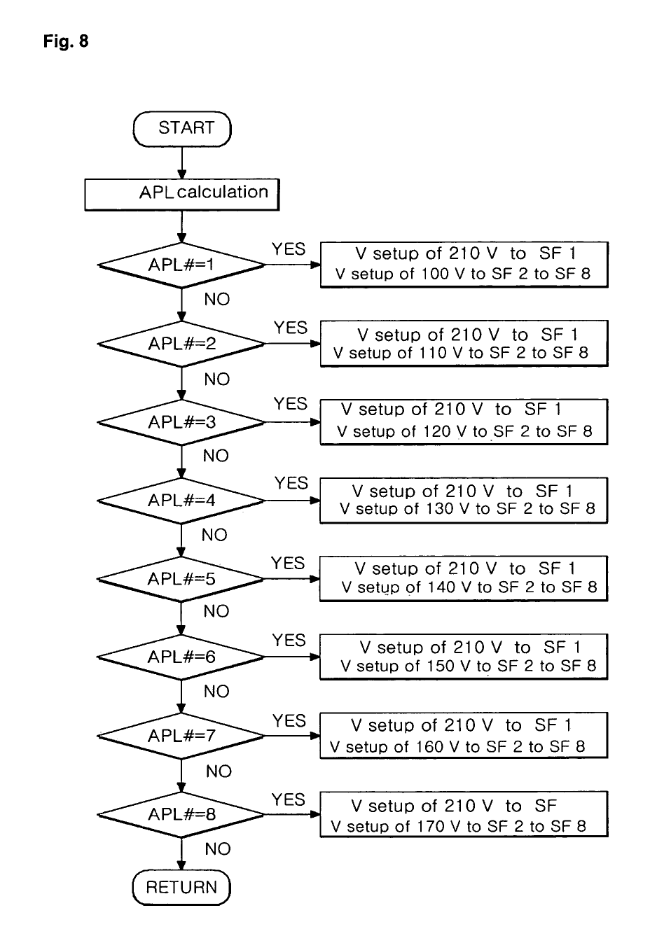

FIG. 8 is a flow chart representing the procedure of control in the initialization control method of plasma display panel according to a third embodiment of the present invention. It is supposed that the number of sub field is eight and the sub field pattern is able to represent maximum 1024 gray level in table 3 and FIG. 8. Table 3 and FIG. 8 show the set up voltage Vsetup of Ramp-up signals in the method for initialization control of a PDP according to the third embodiment of the present invention.

TABLE 3

| | | SF2 | SF3 | SF4 | SF5 | | SF7 | SF8 |
|---|---|---|---|---|---|---|---|---|
| | SF1 (1k) | (2k) | (4k) | (8k) | (16k) | SF6 (32k) | (64k) | (128k) |
| APL1 | 210 V | 100 V | 100 V | 100 V | 100 V | 100 V | 100 V | 100 V |
| APL2 | 210 V | 110 V | 110 V | 110 V | 110 V | 110 V | 110 V | 110 V |
| APL3 | 210 V | 120 V | 120 V | 120 V | 120 V | 120 V | 120 V | 120 V |
| APL4 | 210 V | 130 V | 130 V | 130 V | 130 V | 130 V | 130 V | 130 V |
| APL5 | 210 V | 140 V | 140 V | 140 V | 140 V | 140 V | 140 V | 140 V |
| APL6 | 210 V | 150 V | 150 V | 150 V | 150 V | 150 V | 150 V | 150 V |
| APL7 | 210 V | 160 V | 160 V | 160 V | 160 V | 160 V | 160 V | 160 V |
| APL8 | 210 V | 170 V | 170 V | 170 V | 170 V | 170 V | 170 V | 170 V |

A first sub field SF1 in which frames begin requires stabilization most in initialization. Hence, write discharge for initialization is performed in the first sub field SF1 with the voltage of 180V˜240V, preferably with 210V set up voltage of Ramp-up signals regardless of APL.

Setup voltage of Ramp-up signals varies with APL in sub fields SF2 to SF8 except the first sub field SF1. When APL is low, in other words, when APL is calculated as low value to decrease black luminance in the dark screen, set up voltage Vsetup of the second sub field to eighth sub field SF2 to SF8 becomes low.

As shown in table 3 and FIG. 8, if APL is calculated as a first APL group APL1, set up voltage Vsetup of the second sub field to eighth sub field SF2 to SF8 is determined in 100V that is the lowest value. If APL is calculated as a second APL group APL2, set up voltage Vsetup of the second sub field to eighth sub field SF2 to SF8 is determined in 110V.

Likewise, set up voltage Vsetup is determined high in accordance with high APL. If APL is calculated as a seventh APL group APL7, while the screen turns bright, set up voltage Vsetup of the second sub field to eighth sub field SF2 to SF8 is determined in 160V. If APL is calculated as a eighth APL group APL8, set up voltage Vsetup of the second sub field to eighth sub field SF2 to SF8 is determined in 170V.

The method for initialization control of a PDP according to a fourth embodiment of the present invention decreases the set up voltage Vsetup of the sub fields, such as the second sub field to eighth sub field SF2 to SF8 except a first sub field SF1, when APL is higher and APL is lower.

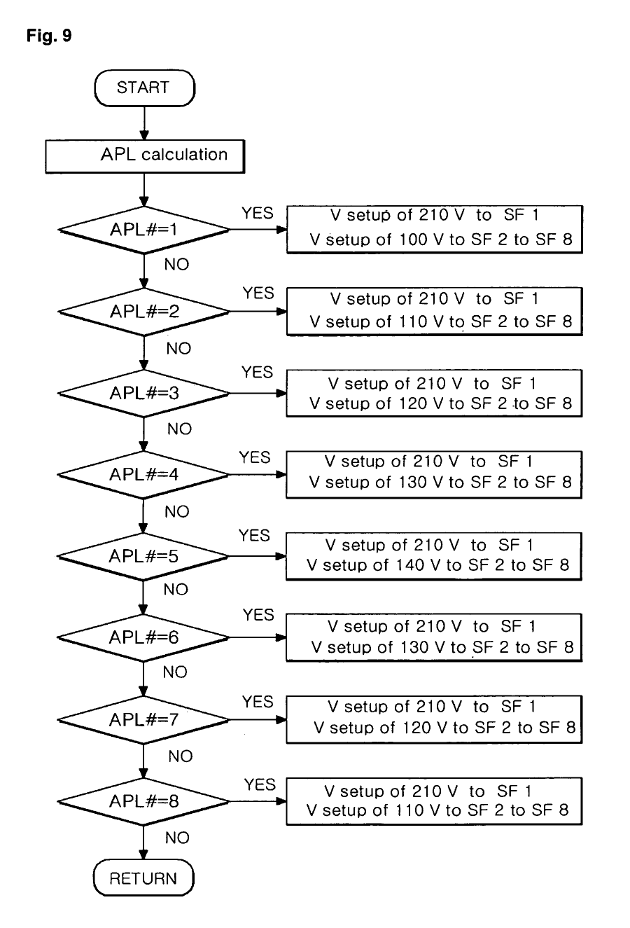

FIG. 9 is a flow chart representing the procedure of control in the initialization control method of plasma display panel according to the fourth embodiment of the present invention. It is supposed that the number of sub field is eight and the sub field pattern is able to represent maximum 1024 gray level in table 4 and FIG. 9. Table 4 and FIG. 9 show the set up voltage Vsetup of Ramp-up signals in the method for initialization control of a PDP according to the fourth embodiment of the present invention.

TABLE 4

| | | SF2 | SF3 | SF4 | SF5 | | SF7 | SF8 |
|---|---|---|---|---|---|---|---|---|
| | SF1 (1k) | (2k) | (4k) | (8k) | (16k) | SF6 (32k) | (64k) | (128k) |
| APL1 | 210 V | 100 V | 100 V | 100 V | 100 V | 100 V | 100 V | 100 V |
| APL2 | 210 V | 110 V | 110 V | 110 V | 110 V | 110 V | 110 V | 110 V |
| APL3 | 210 V | 120 V | 120 V | 120 V | 120 V | 120 V | 120 V | 120 V |
| APL4 | 210 V | 130 V | 130 V | 130 V | 130 V | 130 V | 130 V | 130 V |
| APL5 | 210 V | 140 V | 140 V | 140 V | 140 V | 140 V | 140 V | 140 V |
| APL6 | 210 V | 130 V | 130 V | 130 V | 130 V | 130 V | 130 V | 130 V |
| APL7 | 210 V | 120 V | 120 V | 120 V | 120 V | 120 V | 120 V | 120 V |
| APL8 | 210 V | 110 V | 110 V | 110 V | 110 V | 110 V | 110 V | 110 V |

A first sub field SF1 in which frames begin requires stabilization most in initialization. Hence, write discharge for initialization is performed in the first sub field SF1 with the voltage of 180V˜240V, preferably with 210V set up voltage of Ramp-up signals regardless of APL. Setup voltage of Ramp-up signals varies with APL in sub fields SF2 to SF8 except the first sub field SF1.

When APL is low, in other words, when APL is calculated as low value to decrease black luminance in the dark screen, set up voltage Vsetup of the second sub field to eighth sub field SF2 to SF8 becomes low. When APL is high, in other words, in the bright screen, priming effect is strong due to frequent discharge. Accordingly, write discharge for initialization may be stably performed in the entire discharge cells even though set up voltage Vsetup is low in the bright screen. Hence, If APL is calculated as high value, set up voltage Vsetup of the second sub field to eighth sub field SF2 to SF8 becomes low.

As shown in table 4 and FIG. 9, if APL is calculated as a first APL group APL1, set up voltage Vsetup of the second sub field to eighth sub field SF2 to SF8 is determined in 100V that is the lowest value. If APL is calculated as a second APL group APL2, set up voltage Vsetup of the second sub field to eighth sub field SF2 to SF8 is determined in 110V. Likewise, set up voltage Vsetup is determined high in accordance with high APL.

If APL is calculated as a sixth APL group APL6, while the screen turns bright, set up voltage Vsetup of the second sub field to eighth sub field SF2 to SF8 goes back to low level, determined in 130V. The brighter the screen is, the lower set up voltage Vsetup is determined. That is, If APL is calculated as a seventh APL group APL7, set up voltage Vsetup of the second sub field to eighth sub field SF2 to SF8 is determined in 120V. If APL is calculated as a eighth APL group APL8, set up voltage Vsetup of the second sub field to eighth sub field SF2 to SF8 is determined in 110V.

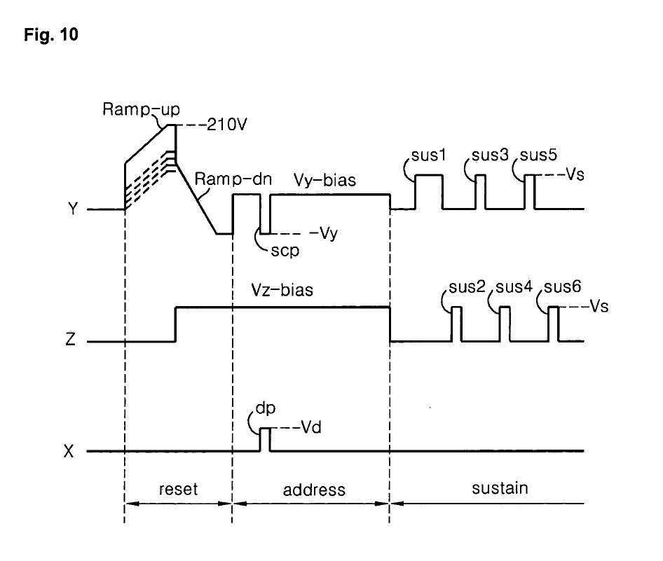

FIG. 10 is a waveform diagram representing the set-up voltage of Ramp-up waveform which varies with the average luminance in the initialization control method of plasma display panel according to the third embodiment and the fourth embodiment of the present invention. FIG. 10 shows set up voltage Vsetup in the initialization control method of plasma display panel according to the third embodiment and the fourth embodiment of the present invention.

As shown in FIG. 10, the initialization control method of plasma display panel according to the third embodiment and the fourth embodiment of the present invention variably determined between 100V and 200V as set up voltage Vsetup of Ramp-up signals is represented as a dotted line at least in some sub fields according to APL. If set up voltage Vsetup is determined as the dotted line, in such degree, write discharge by Ramp-up signals is performed weakly. Subsequently, black luminance may be reduced.

The initialization control method of plasma display panel according to the fifth embodiment of the present invention increases the number of sub fields abbreviating Ramp-up signals or determines set up voltage Vsetup of Ramp-up signals as high voltage at least in some sub fields as APL becomes low. Also, the initialization control method of plasma display panel according to the fifth embodiment of the present invention decreases the number of of sub fields abbreviating Ramp-up signals or determines set up voltage Vsetup of Ramp-up signals as high voltage at least in some sub fields as APL becomes high.

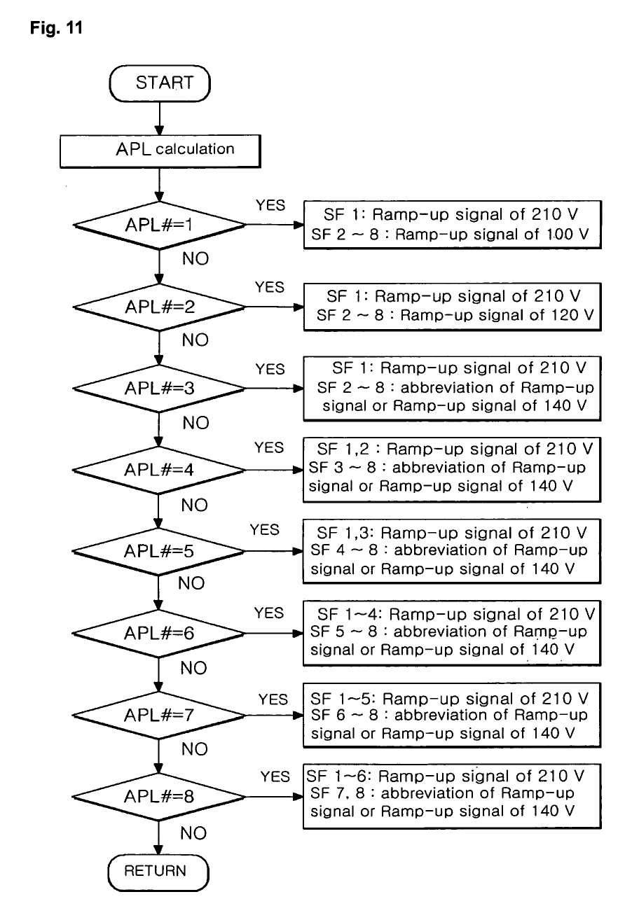

FIG. 11 is a flow chart representing the procedure of control in the initialization control method of plasma display panel according to a fifth embodiment of the present invention.

It is supposed that the number of sub field is eight and the sub field pattern is able to represent maximum 1024 gray level in table 5 and FIG. 11. Table 5 and FIG. 11 show the set up voltage Vsetup of Ramp-up signals and show that whether Ramp-up signals are abbreviated or not, in the method for initialization control of a PDP according to the fifth embodiment of the present invention.

| | | SF2 | SF3 | | SF5 | SF6 | | SF8 |
|---|---|---|---|---|---|---|---|---|
| | SF1 (1k) | (2k) | (4k) | SF4 (8k) | (16k) | (32k) | SF7 (64k) | (128k) |
| APL1 | ◯ | 100 V | 100 V | 100 V | 100 V | 100 V | 100 V | 100 V |
| APL2 | ◯ | 120 V | 120 V | 120 V | 120 V | 120 V | 120 V | 120 V |
| APL3 | ◯ | X | X | X | X | X | X | X |
| APL4 | ◯ | ◯ | X | X | X | X | X | X |
| APL5 | ◯ | ◯ | ◯ | X | X | X | X | X |
| APL6 | ◯ | ◯ | ◯ | ◯ | X | X | X | X |
| APL7 | ◯ | ◯ | ◯ | ◯ | ◯ | X | X | X |
| APL8 | ◯ | ◯ | ◯ | ◯ | ◯ | ◯ | X | X |

In Table 5, O means sub field in which Ramp-up signals are not abbreviated. Ramp-up signal of normal 210V set up voltage Vsetup is applied to such sub fields. X means sub field in which Ramp-up signals are abbreviated or sub field to which Ramp-up signal determined in low level in 140V set up voltage Vsetup is applied.

Write discharge for initialization is performed in a first sub field SF1 with Ramp-up signal of 210V set up voltage. In the other sub fields except the first sub field SF1, Ramp-up signals are abbreviated or set up voltage Vsetup of Ramp-up signals may be variable. When APL is low, in other words, when APL is calculated as low value to decrease black luminance in the dark screen, Ramp-up signals are abbreviated or Ramp-up signal of low set up voltage is applied to at least some sub fields in a second sub field to a eighth sub field SF2 to SF8.

As shown in table 5 and FIG. 11, if APL is calculated as a first APL group APL1, Ramp-up signals of 100V set up voltage is applied to the second sub field to eighth sub field SF2 to SF8. If APL is calculated as a second APL group APL2, Ramp-up signals of 120V set up voltage is applied to the second sub field to eighth sub field SF2 to SF8.

If APL is calculated as a third APL group APL3, Ramp-up signals are abbreviated or Ramp-up signals of 140V set up voltage is applied to the second sub field to eighth sub field SF2 to SF8. If APL is calculated as a fourth APL group APL4, Ramp-up signals of 210V set up voltage is applied to the first sub field and second sub field SF1, SF2. In this case, Ramp-up signals are abbreviated in the third sub field to eighth sub field SF3 to SF8 or Ramp-up signals of 140V set up voltage is applied to the third sub field to eighth sub field SF3 to SF8. If APL is calculated as a fifth APL group APL5, Ramp-up signals of 210V set up voltage is applied to the first sub field to third sub field SF1 to SF3. In this case, Ramp-up signals are abbreviated in the fourth sub field to eighth sub field SF4 to SF8 or Ramp-up signals of 140V set up voltage is applied to the fourth sub field to eighth sub field SF4 to SF8.

Likewise, when APL is high, the number of sub fields abbreviating Ramp-up signals are decreased or the number of sub fields to which Ramp-up signals of normal set up voltage is applied are decreased. That is, If APL is calculated as a seventh APL group APL7, while the screen turns bright, Ramp-up signals of 210V set up voltage is applied to the first sub field to fifth sub field SF1 to SF5. In this case, Ramp-up signals are abbreviated in the sixth sub field to eighth sub field SF6 to SF8 or Ramp-up signals of 140V set up voltage is applied to the sixth sub field to eighth sub field SF6 to SF8. If APL is calculated as a eighth APL group APL8, Ramp-up signals of 210V set up voltage is applied to the first sub field to sixth sub field SF1 to SF6. In this case, Ramp-up signals are abbreviated in the seventh sub field and eighth sub field SF7, SF8 or Ramp-up signals of 140V set up voltage is applied to the seventh sub field and eighth sub field SF7, SF8.

As shown in table 6, the initialization control method of plasma display panel according to the fifth embodiment of the present invention increases the number of sub fields abbreviating Ramp-up signals when APL is low, while low set up voltage Vsetup of Ramp-up signals are determined when APL is high at least in some sub field.

TABLE 6

| | | SF2 | SF3 | SF4 | SF5 | SF6 | | SF8 |
|---|---|---|---|---|---|---|---|---|
| | SF1 (1k) | (2k) | (4k) | (8k) | (16k) | (32k) | SF7 (64k) | (128k) |
| APL1 | ◯ | X | X | X | X | X | X | X |
| APL2 | ◯ | ◯ | X | X | X | X | X | X |
| APL3 | ◯ | ◯ | ◯ | X | X | X | X | X |
| APL4 | ◯ | ◯ | ◯ | ◯ | X | X | X | X |
| APL5 | ◯ | 140 V | 140 V | 140 V | 140 V | 140 V | 140 V | 140 V |
| APL6 | ◯ | 150 V | 150 V | 150 V | 150 V | 150 V | 150 V | 150 V |
| APL7 | ◯ | 160 V | 160 V | 160 V | 160 V | 160 V | 160 V | 160 V |
| APL8 | ◯ | 170 V | 170 V | 170 V | 170 V | 170 V | 170 V | 170 V |

The initialization control method of plasma display panel according to the sixth embodiment of the present invention abbreviates Ramp-up signals or set up voltage of Ramp-up signals is determined in low level, when APL is lower or higher.

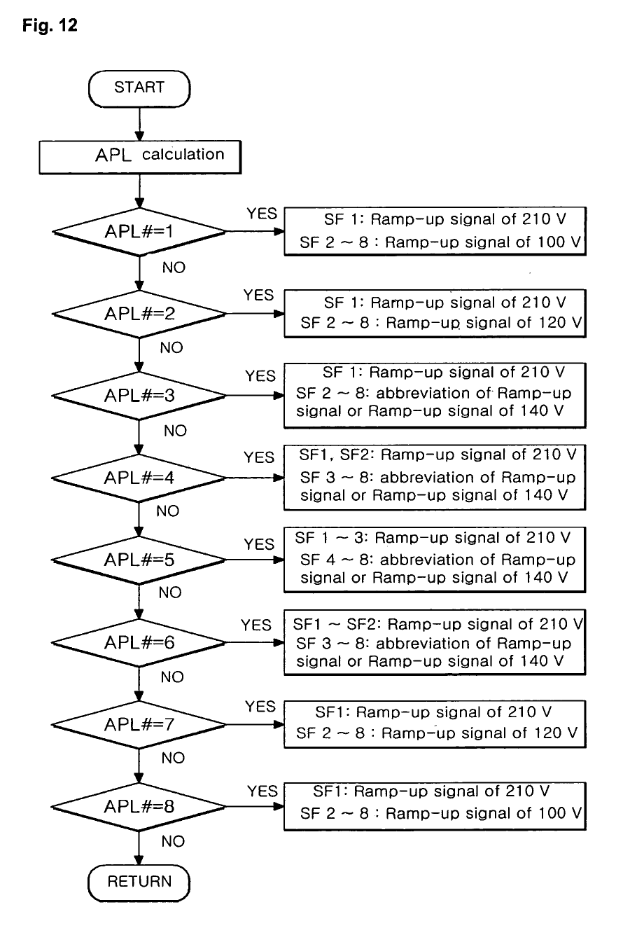

FIG. 12 is a flow chart representing the procedure of control in the initialization control method of plasma display panel according to a sixth embodiment of the present invention.

It is supposed that the number of sub field is eight and the sub field pattern is able to represent maximum 1024 gray level in table 7 and FIG. 12. Table 7 and FIG. 12 show the set up voltage Vsetup of Ramp-up signals and show that whether Ramp-up signals are abbreviated or not, in the method for initialization control of a PDP according to the fifth embodiment of the present invention.

TABLE 7

| | | SF2 | SF3 | SF4 | SF5 | SF6 | | SF8 |
|---|---|---|---|---|---|---|---|---|
| | SF1 (1k) | (2k) | (4k) | (8k) | (16k) | (32k) | SF7 (64k) | (128k) |
| APL1 | ◯ | 100 V | 100 V | 100 V | 100 V | 100 V | 100 V | 100 V |
| APL2 | ◯ | 120 V | 120 V | 120 V | 120 V | 120 V | 120 V | 120 V |
| APL3 | ◯ | X | X | X | X | X | X | X |
| APL4 | ◯ | ◯ | X | X | X | X | X | X |
| APL5 | ◯ | ◯ | ◯ | X | X | X | X | X |
| APL6 | ◯ | ◯ | X | X | X | X | X | X |
| APL7 | ◯ | 120 V | 120 V | 120 V | 120 V | 120 V | 120 V | 120 V |
| APL8 | ◯ | 100 V | 100 V | 100 V | 100 V | 100 V | 100 V | 100 V |

A first sub field SF1 in which frames begin requires stabilization most in initialization. Hence, write discharge for initialization is performed in the first sub field SF1 with the voltage of 180V˜240V, preferably with 210V set up voltage of Ramp-up signals regardless of APL. The number of sub fields abbreviating Ramp-up signals are increased when APL is low and high in the other sub fields SF2 to SF8 except the first sub field SF1. In this case, set up voltage Vsetup is determined in low level.

As shown in table 7 and FIG. 12, if APL is calculated as a first APL group APL1, set up voltage in the second sub field to eighth sub field SF2 to SF8 is determined in 100V that is low level. If APL is calculated as a second APL group APL2, set up voltage in the second sub field to eighth sub field SF2 to SF8 is determined in 120V. If APL is calculated as a third APL group APL3, Ramp-up signals are abbreviated in the second sub field to eighth sub field SF2 to SF8 or Ramp-up signals of 140V set up voltage is applied to the second sub field to eighth sub field SF2 to SF8.

If APL is calculated as a fourth APL group APL4, Ramp-up signals of 210V set up voltage is applied to the first sub field and the second sub field SF1, SF2. In this case, Ramp-up signals are abbreviated in the third sub field to eighth sub field SF3 to SF8 or Ramp-up signals of 140V set up voltage is applied to third sub field to eighth sub field SF3 to SF8. If APL is calculated as a fifth APL group APL5, Ramp-up signals of 210V set up voltage is applied to the first sub field to the third sub field SF1 to SF3. In this case, Ramp-up signals are abbreviated in the fourth sub field to eighth sub field SF4 to SF8 or Ramp-up signals of 140V set up voltage is applied to the fourth sub field to eighth sub field SF4 to SF8.

If APL is higher than a sixth group APL6, the number of sub fields abbreviating Ramp-up signals are increased or set up voltage is decreased. That is, If APL is calculated as the fifth APL group APL5, while the screen turns bright, Ramp-up signals of 210V set up voltage is applied to the first sub field and the second sub field SF1, SF2. In this case, Ramp-up signals are abbreviated in the third sub field to eighth sub field SF3 to SF8 or Ramp-up signals of 140V set up voltage is applied to the third sub field to the eighth sub field SF3 to SF8.

If APL is calculated as the seventh APL group APL7, Ramp-up signals of 210V set up voltage is applied to the first sub field. In this case, Ramp-up signals of 120V set up voltage is applied to the second sub field to eighth sub field SF2 to SF8. If APL is calculated as the eighth APL group APL8, Ramp-up signals of 210V set up voltage is applied to the first sub field. In this case, Ramp-up signals of 100V set up voltage is applied to the second sub field to eighth sub field SF2 to SF8.

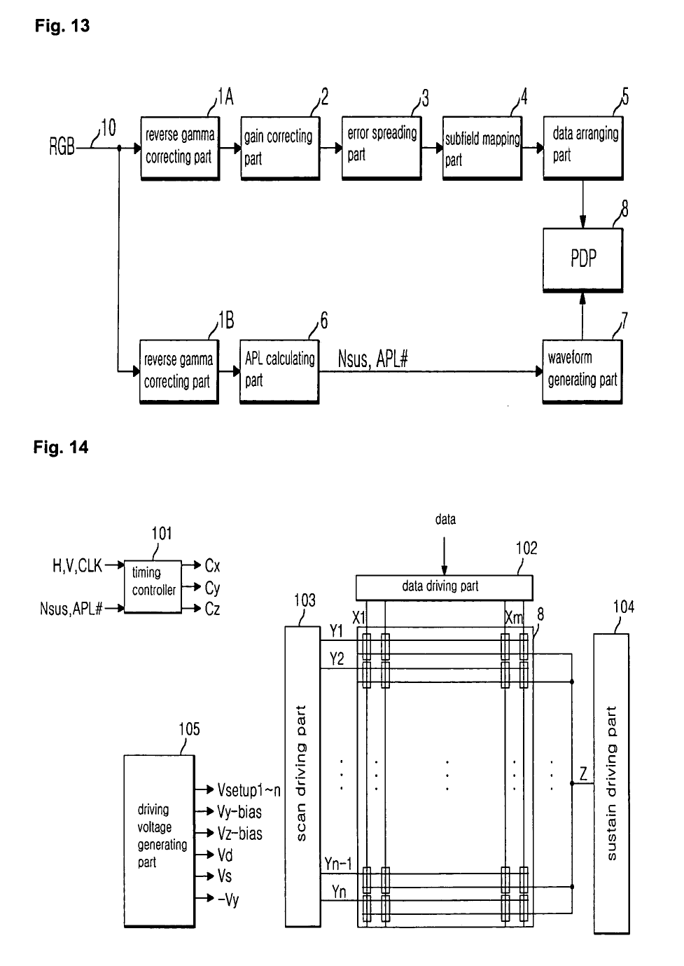

FIG. 13 is a block diagram representing the initialization control means of plasma display panel according to the embodiments of the present invention. FIG. 14 is a block diagram representing the waveform generating part in FIG. 13 in detail.

Referring to FIG. 13 and FIG. 14, an apparatus for initialization control of plasma display panel according to the present invention includes a gain correcting part 2, an error spreading part 3 and a subfield mapping part 4 connected between a first reverse gamma correcting part 1A and a data arranging part 5, and includes an APL calculating part 6 connected between a second reverse gamma correcting part 1B and a waveform generating part 7.

The first and second reverse gamma correcting parts 1A and 1B perform reverse gamma correction on RGB digital video data from an input line 10, converting luminance corresponding to a gray scale of a video signal into a linear value.

The gain correcting part 2 compensates a color temperature by adjusting an effective gain according to respective data of RGB colors.

The error spreading part 3 minutely adjusts a luminance value by spreading to adjacent cells a quantization error of the RGB input digital video data received from the gain correcting part 2. In that case, the error spreading part 3 divides data into integer part and prime number part. Prime number part is multiplied by Floid-Steinberg coefficient.

The subfield mapping part 4 maps data received from the error spreading part 3 to a subfield pattern stored previously according to each bit and supplies the mapped data to the data arranging part 5.

The data arranging part 5 supplies a data driving part 102 of a PDP 8 with digital video data received from the subfield mapping part 4. The data driving part 102 is connected to address electrodes X1 to Xm of the PDP 8. The data driving part 102 latches data received from the data arranging part 5 on a horizontal line basis and supplies the latched data to the address electrodes X1 to Xm of the PDP 8 in the part of one horizontal period.

APL calculating part 6 calculates an APL of data received from the second reverse gamma correcting part 1B, and derives the number of sustain pulses, Nsus, corresponding to the calculated. Further, the APL calculating part 6 outputs identification data APL# of APL group including the calculated APL.

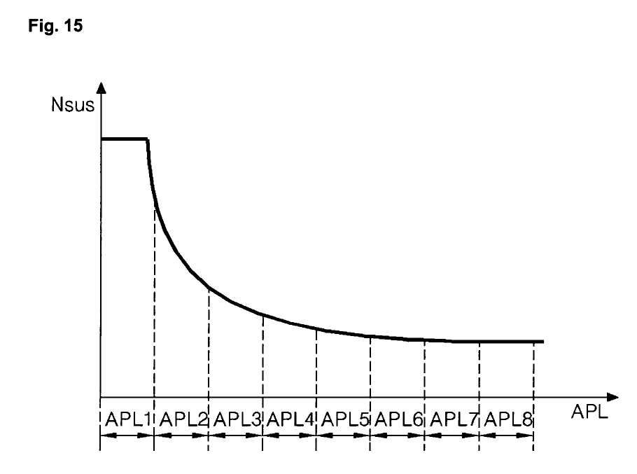

FIG. 15 is a graphical representation of APL calculated in APL calculating part shown in FIG. 13 and the number of sustain pulse according to APL. As described above, the APL calculating part 6 searches lookup table registering the number of sustain pulse corresponding to APL, reading out sustain number data Nsus and identification data APL# of APL group as shown in FIG. 15.

As shown in FIG. 14, the waveform generating part 7 includes a timing controller 101, driving voltage generating part 105, scan driving part 103 and sustain driving part 104.

The timing controller 101 receives vertical/horizontal synchronization signals H, V and clock signal CLK, generating timing control signals Cx, Cy and Cz necessary for the respective driving parts 102, 103 and 104, and supplies the timing control signals Cx, Cy and Cz to corresponding driving parts 102, 103 and 104, thus controlling the respective driving parts 102, 103 and 104.

The data control signal Cx includes a sampling clock for sampling a data, a latch control signal, and a switch control signal for controlling an on/off time of an energy recovery circuit and a driving switch element. The scan control signal Cy includes a switch control signal for controlling an on/off time of an energy recovery circuit and a driving switch element within the scan driving part 103. Also, the sustain control signal Cz includes a switch control signal for controlling an on/off time of an energy recovery circuit and a driving switch element within the sustain driving part 104.

The timing controller 101 controls the scan control signal Cy and the sustain control signal Cz according to the sustain pulse number data Nsus, thus controlling the number of sustain pulse. In this case, as described above, the timing controller 101 is also able to abbreviate Ramp-up signals or to control the set up voltage Vsetup in response to the APL group identification data APL#.

The scan driving part 103 serves to supply Ramp-up signals and Ramp-dn signals to the scan electrodes Y1 to Ym during the reset period, sequentially providing a scan pulse scp to the scan electrodes Y1 to Ym during the address period under the control of the timing controller 101. The scan driving part 103 supplies sustain pulses sus1, sus3 and sus5 to the scan electrodes Y1 to Ym during the sustain period under the control of the timing controller 101. In particular, as described above, the scan driving part 103 is selectively able to abbreviate Ramp-up signals or to control the set up voltage Vsetup1 to Vsetupn, at least, in some field according to APL under the control of the timing controller 101.

The sustain driving part 104 serves to supply DC bias voltage Vz-bias during address period under the control of the timing controller 101. Then, the sustain driving part 104 and the scan driving part 103, in turn, serve to supply sustain pulses sus2, sus4 and sus6 during the sustain period.

The driving voltage generator 105 generates a set-up voltage Vsetup1 to Vsetupn of Ramp-up signals Ruy, Ruz, a scan voltage Vy of the negative polarity, DC bias voltage Vy-bias, Vz-bias, a sustain voltage Vs, a data voltage Vd and the like. These driving voltages can vary depending on the composition of a discharge gas or the construction of a discharge cell.

In the mean time, as described above, the present invention controls the number of Ramp-up waveforms or the set up voltage. Furthermore, it is also possible to control the tilt of Ramp-up waveforms or to control the number or voltage of Ramp-up waveforms.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for initialization control of a plasma display panel, the method comprising the steps of:
time-dividing a frame period into a plurality of sub fields which are capable of abbreviating an initialization signal for initialization discharge or are capable of controlling the voltage of the initialization signal according to an average luminosity of input image; and
increasing the number of sub fields abbreviating the initialization signal or increasing the number of sub fields having low initialization signal voltage when the average luminosity of input image is lower than a average luminosity of previous input image.

2. A method for initialization control of a plasma display panel, the method comprising the steps of:
time-dividing a frame period into a plurality of sub fields which are capable of abbreviating an initialization signal for initialization discharge or are capable of controlling the voltage of the initialization signal according to an average luminosity of input image;
performing cell initialization by means of the initialization signal in each sub field when the average luminosity of input image is a predetermined value;
increasing the number of sub fields abbreviating the initialization signal or increasing the number of sub fields having low initialization signal voltage when the average luminosity of input image is lower than the predetermined value; and
increasing the number of sub fields abbreviating the initialization signal or increasing the number of sub fields having low initialization signal voltage when the average luminosity of input image is higher than the predetermined value.

3. The method of claim 2, wherein the initialization signal is a ramp signal for performing write discharge as weak discharge with gradual rising of voltage.

4. An apparatus for initialization control of a plasma display panel comprising:
a plasma display panel which is time-divided driven with a plurality of sub fields which are capable of abbreviating an initialization signal for initialization discharge or are capable of controlling the voltage of the initialization signal according to an average luminosity of input image;
an APL calculating part caculating the average luminosity of input image; and
an initialization control part increasing the number of sub fields abbreviating the initialization signal or increasing the number of sub fields having low initialization signal voltage when the average luminosity of input image calculated by the APL calculating part is lower than a average luminosity of previous input image.

5. An apparatus for initialization control of a plasma display panel comprising:
a plasma display panel which is time-divided driven with a plurality of sub fields which are capable of abbreviating an initialization signal for initialization discharge or are capable of controlling the voltage of the initialization signal according to an average luminosity of input image;
an APL calculating part caculating the average luminosity of input image;
a first initialization control part providing the initialization signal with the plasma display panel in each sub field when the average luminosity of input image calculated by the APL calculating part is a predetermined value;
a second initialization control part increasing the number of sub fields abbreviating the initialization signal or increasing the number of sub fields having low initialization signal voltage when the average luminosity of input image is lower than the predetermined value; and
a third initialization control part increasing the number of sub fields abbreviating the initialization signal or increasing the number of sub fields having low initialization signal voltage when the average luminosity of input image is higher than the predetermined value.

6. The apparatus of claim 5, wherein the initialization signal is a ramp signal for performing write discharge as weak discharge with gradual rising of voltage.

7. The apparatus of claim 4, wherein the initialization control part comprises:
an initialization signal generating part generating the initialization signal; and
a control part for controlling the initialization signal generating part in response to the average luminosity signal calculated by the APL calculating part.

8. The apparatus of claim 5, wherein the first, second and the third initialization control part comprise:
an initialization signal generating part generating the initialization signal; and
a control part for controlling the initialization signal generating part in response to the average luminosity signal calculated by the APL calculating part.

9. The method of claim 1, wherein the initialization signal is a ramp signal for performing write discharge as weak discharge with gradual rising of voltage.

10. The method of claim 4, wherein the initialization signal is a ramp signal for performing write discharge as weak discharge with gradual rising of voltage.

11. The apparatus of claim 4, wherein the initialization signal is a ramp signal for performing write discharge as weak discharge with gradual rising of voltage.
